(19) United States
(12) Patent Application Publication
(10) Pub. No.: US 2010/0171019 A1
(43) Pub. Date: Jul. 8, 2010

(54) Recycling Container Hanger Bracket

(76) Inventors: William Funston, Millgrove (CA); James Finnamore, Millgrove (CA)

Correspondence Address: EDWARD H. OLDHAM, 20 JAMESON DRIVE, DUNDAS, ON, L9H 5A2, CA

(21) Appl. No.: 12/319,252

(22) Filed: Jan. 6, 2009

(51) Int. Cl. B65F 1/14

(52) U.S. Cl. 248/312.1; 248/311.2

(57) ABSTRACT

This invention describes a hanger for attaching to a wall of a suitable storage space for hanging a “blue box” thereon. The hanger is preferably composed of a one piece molded plastic material and makes use of the universal shape of the “blue box” container to hang the “blue box” from the rim which is omnipresent on the “blue box”.

The hanger is of such shape that it is able to grasp the rim of the “blue box” when the “blue box” is suitably placed thereon. A projecting lip carried by the hanger holds the rim of a suitably placed container thereon.

A projecting abutment molded into the hanger is located on the opposite side of the hanger from the wall to abut the container and serves to maintain the container in a vertical storing condition

This invention relates to a hanger bracket which when installed on a wall or other suitable vertical surface which serves to conveniently mount a Recycling Container thereon. A few words about the universal shape of recycling containers need to be said here so that the invention described here will not be taken incorrectly. Recycling boxes which are sometimes referred to as “Blue Boxes” have a shape which is universal, and it is because of this standard universal shape that this invention is able to deliver its promise.

The shape of the “blue box” which makes this invention possible is that the box is shaped to have flat rectangularly shaped bottom portion (which is usually integrally joined or otherwise connected to the sides of the recycling container); the sides of the container slope gently outwardly to yield a container which is somewhat bigger at the top than at the bottom.

Each of the four sides extends upwardly the same distance and terminates in a rim or lip which extends completely around the top of the recycling container for all the recycling containers the rim is of a universal shape. That is what allows this invention to be successful. The rim is always of the same shape and each container has dimensions which are faithfully repeated for each recycling container.

The hanger bracket which is about to be described and which is the subject of this invention is preferably molded to form a one piece assembly of a suitable plastic material such as nylon.

### BACKGROUND OF THE INVENTION

Blue recycling containers have been in existence for quite some time. With the advent of different coloured recycling boxes and the subsequent need for separation of recyclable goods into different categories, the ability to hang the recycling containers on a wall so that the contents may be categorized and thus the containers may now are conveniently separated so that they may hold recyclable material having different characteristics. Recycling materials may thus be sorted into the variously coloured containers as they are conveniently mounted on the wall.

By being mounted on a wall, the separation of recyclable material into the various types becomes an easier task, and the whole assembly of recycling containers takes up much less floor space than does prior art methods of storing the container containing the recycled material.

### SUMMARY OF THE INVENTION

This invention which takes advantage of the universal shape of the recycling container, especially the rim or lip at the top of the container, to yield a simple means of hanging such a container. The rim of such container may be formed or molded with or without reinforcing gussets located on the underside of the rim to increase the strength of the container, and the hanger is designed to accommodate the inclusion of gussets on the container rim.

Thus, it is seen that the hanger of this invention is easily mounted on a wall or some other suitable vertical surface by screwing it with a suitable screw into an underlying stud and if the container is expected to carry a much heavier load, two such hangers may be utilized to hang the container thereon instead of one.

The recycling container is then mounted on the hanger now installed on the wall by “hooking” the upper rim over the hanger(s) to secure it in place. The hanger is designed to keep the container in its vertical orientation because of its construction. The recycling container is now ready to be used.

### BRIEF DESCRIPTION OF THE DRAWINGS

FIG. 1 is a perspective view of a standard recycling container;

FIG. 2 is a perspective view of the container of FIG. 1 showing a section of the rim removed;

FIG. 3 shows a perspective of the hanger bracket of this invention;

FIG. 4 shows a sectional view of the top of a container being hung on the hanger of this invention so that the container is hung in place and ready to be used.

### BRIEF DESCRIPTION OF THE PREFERRED EMBODIMENT

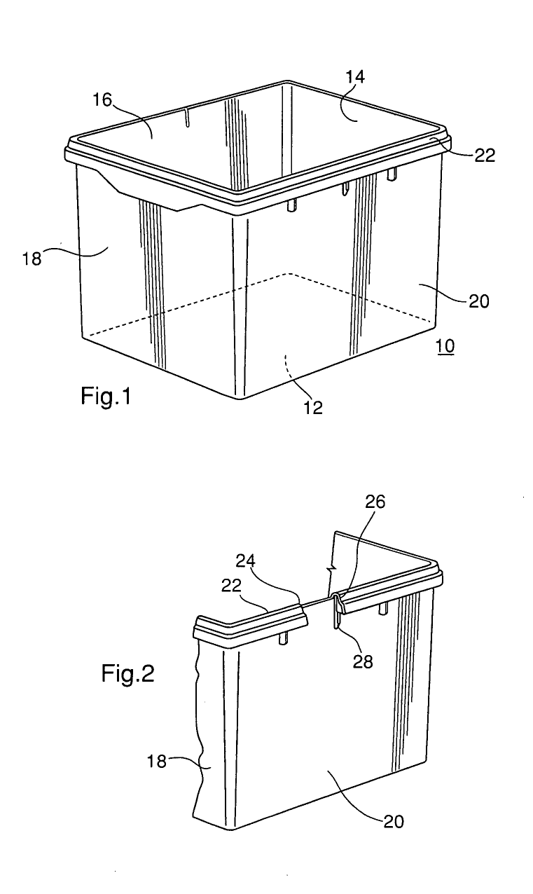

Referring now to FIG. 1 of the drawings, a standard universal recycling container 10 is shown. Container 10 has a floor of rectangular shape 12 from which four walls 14, 16, 18, and 20 integrally extend. Walls 14-20 are generally integrally molded to floor 12 and gently slope outwardly so that the top of container 10 is substantially larger than the floor 12. Located at the top of each wall is a continuous rim 22 which extends all the way around the top of container 10. The rim 22 has a specific consistent shape (which is essential to the success of this invention) so as to structurally strengthen the container 10 at the top thereof.

FIG. 2 shows a partial sectional view of the container of FIG. 1, showing the walls 18 and 20 and in particular the configuration of the rim or lip 22 thereof. Rim 22 is shown to be broken at 24 to better illustrate the configuration of rim 22. A gusset 28 is shown where it is formed in rim 22; gusset 28 serves to increase the strength of the rim 20 and walls 14-20.

Container 10 will usually be formed as a one piece injection molded article. Because of its universal shape, this invention enables a user to succeed in the separation of recyclable goods into categories previously judged to be too time consuming and too difficult to do. Now the containers may be hung from the walls of the storage area where previously these containers used to stored in a haphazard manner on the floor. Gussets such as that shown at 28 may be formed in container 10 during the manufacture of the recycling container 10.

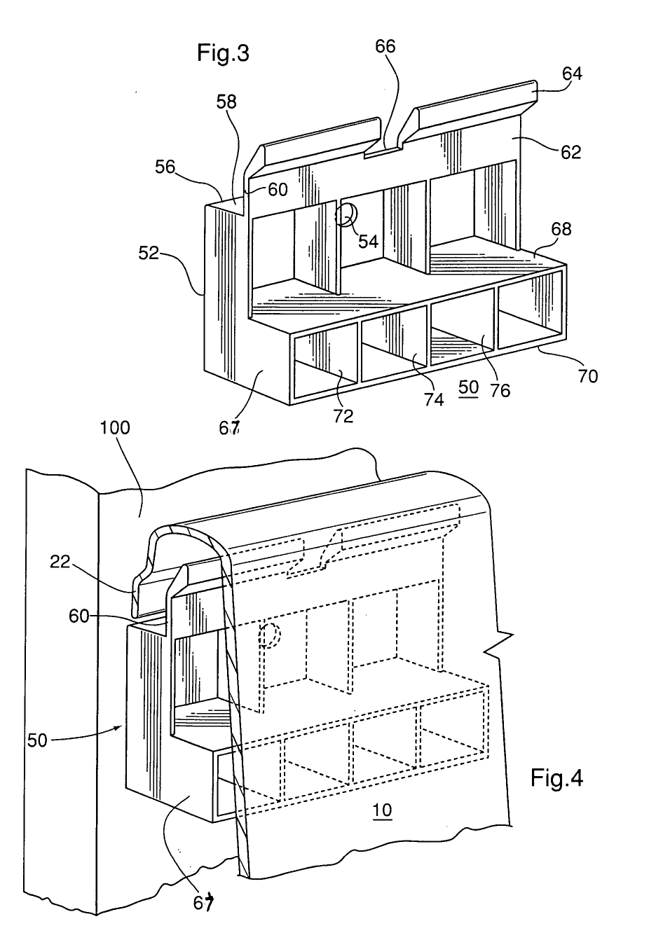

The device 50 which is the subject of this application is shown in perspective in FIG. 3. Here the device 50 is shown to be of irregular shape and is illustrated as it exists after it has been injected molded in a manufacturing operation. Device 50 is injected molded from a suitable material such as nylon, and is provided with a flat surface at means of mounting it on a vertical wall of the storage area where it is desired to be hung.

Thus device 50 is a shown having a substantially flat vertical rear wall 52 in which a hole 54 is provided (shown in phantom) for attaching device 50 to a suitable wall in the container storage area.

Located above the rear wall 52 and extending orthogonally thereto is a wall 56 having an upper surface 58 which is of a predetermined width. Located at the first predetermined width from rear wall is a vertical upstanding wall 60 which it is seen as actually consisting of two portions, 62 and 64. Portion 62 is seen to be substantially vertical section but portion 64 has a definite slope and is somewhat wedge shaped. A cutout 66 is shown in the top portion of 64 of the device 50, to allow the device 50 to accept the rim 22 of the container 10. A gusset such as 28 will fit into the cutout 66 provided in wedge-shaped wall 64.

Located at the lower portion of device 50 is projecting portion 66. The projection 67 extends away from surface 52 a second critical distance. Projection 67 is provided with an upper wall 68 and a lower wall 70 in between which are formed a series of ribs 72, 74, and 76. It is to be remembered that device 50 is usually formed as a one piece item resulting from an injected molding operation.

Referring now to FIG. 4, the container 10 is shown having rim 22 “hooked” over the device 50 which is now mounted on a wall 100. It will soon become apparent that the first predetermined width must be the distance that rim 22 extends from the container 10. This allows the container to be accepted by the device 50 and be firmly grasped therein by the wall 60 of the device 50. By making sure that the wall 60 is located at a certain predetermined distance from the wall 100, the rim 22 of container 10 will be accommodated by the device 50 and firmly grasped by the upstanding lip 60 of the device 50.

Cutout 64 is made to accept any gusset 28 which might be present in the underside surface of rim 22, if such gusset should be present cutout 66 may serve as a convenient indexing mechanism for the device 50.

The last dimension that is critical to the success of this invention is the distance that offset 67 projects from the surface 52 of device 50. It is this dimension that maintains the container 10 in a vertical orientation. Because the walls of the container 10 slope outwardly with a predetermined gentle slope, it is necessary to provide a projecting offset to maintain the container in a vertical orientation.

Many modifications and other embodiments of the invention will come to the mind of one skilled in the art having the benefit of the teachings presented in the foregoing description and the associated drawings. Therefore it is to be understood that the invention is not to be limited to the specific embodiments disclosed, and that the modifications and embodiments are intended to be included within the scope of the dependent claims.

1. A hanger which is of irregular shape and which has length, width, and height;
said hanger having three vertical surfaces which are spaced from each other by predetermined distances;
said hanger having a first vertical surface which extends the length of said hanger;
said hanger having a second vertical surface located above said first surface and being displaced from said first surface by a first predetermined distance;
said hanger having a third vertical surface which extends the length of said hanger, which surface is located on the opposite side of said hanger from said first surface, said third surface being displaced from said first surface by a second predetermined distance;
and wherein said first predetermined distance is substantially less than said second predetermined distance.

2. A hanger as claimed in claim 1 wherein said vertical surfaces are parallel.

3. A hanger as claimed in claim 1 or claim 2 wherein said first surface serves as a mounting surface for said hanger, and which surface is provided with means to accommodate fastening said hanger to a mounting surface.

4. A hanger as claimed in claims 1, 2 or 3 in which said second surface is on a lip, which lip extends substantially the length of said hanger, and which serves to receive and grasp a shaped rim of a suitable container when placed upon said hanger.

5. A hanger as claimed in claims 1, 2, or 3 in which said third surface serves as an abutment surface for said hanger and a container to be hung thereon,
said abutment surface serving to abut and contact said suitable container so as to maintain said container in a preferential orientation.

5. An irregularly shaped hanger useful in hanging a standard universally shaped container commonly known as a “blue box” container to a suitable wall, comprising:
a hanger having a length, a width and a height,
said container being provided with four sides integrally extending from a floor of said container, wherein said sides slope gently outwardly from said floor toward the top of said container,
said container has a rim of predetermined specific contour extending around the top of said container,
said hanger having a first surface extending along the length of said hanger, said first surface having means located therein for accommodating a suitable fastener therein for fastening said hanger on a wall,
an upstanding lip extending substantially the length of said hanger located above and to one side of said first surface for receiving and grasping said rim by said hanger,
a second surface located a second predetermined distance from said first surface, said second surface extending substantially the length of said hanger and forming an abutment to bear against said container to maintain said container in a preferred orientation.
